(19) United States
(12) Patent Application Publication
(10) Pub. No.: US 2010/0012067 A1
(43) Pub. Date: Jan. 21, 2010

(54) Gaseous or liquid fuel delivery spark plug

(76) Inventor: John Scott Perez, Tampa, FL (US)

Correspondence Address: John Scott Perez, 1518 Sheridan Forest Drive, Tampa, FL, 33629, US

(21) Appl. No.: 12/459,516

(22) Filed: Jul. 3, 2009

Related U.S. Application Data
(60) Provisional application No. 61/081,138, filed on Jul. 16, 2008.

(51) Int. Cl. F02P 13/00; F02B 51/00

(52) U.S. Cl. 123/151; 123/536

(57) ABSTRACT

A turn-key method of providing a typical gasoline internal combustion engine with a hybrid fuel that is combustible is accomplished with a modified spark plug. The spark plug design is relative to the use of the internal combustion engine and has the capacity to support traditional gasoline consumption in the absence of a hybrid fuel. Both liquid and gaseous hybrid fuels such as natural gas, methane, nitrous oxide, hydrogen, butane, propane, ethanol, etc. can be supported by the spark plug. In addition the design supports the spontaneous electrolysis of water followed by the instantaneous combustion of the electrolysis products Hydrogen & Oxygen back to water. This design accommodates the more modern engine designs which conceal the placement of spark plugs into the head of the engine, rather than previous designs with side arms that inhibit installation.

### RELATED US APPLICATION DATA

Provisional Application No. 61/081,138 filed on Jul. 16, 2008.

### BACKGROUND OF THE INVENTION

The traditional internal combustion engine runs on a 2 or 4 stroke engine cycle using gasoline as the primary combustion fuel. A typical air to fuel ratio for a combustion engine is 14:1. Combustion of the fuel requires oxygen and some compression within the cylinder(s) of the combustion engine. The combustion process occurs when the cylinder(s) are top dead center in the cycle with the fuel compressed. The combustion process is initiated with a high energy Tesla spark introduced by a spark plug when the fuel and oxygen are top dead center.

Hybridization of the engine requires a scientific modification of the air to fuel ratio that supports the volume of air & fuel that will produce stable combustion within the given volume of the cylinder(s) of the engine. The spark plug is an extension of the cylinders combustion chamber which has an acceptable absolute error relative to how far that extension can be made. The extension volume is usually proportional in size relative to the size of the engines cylinder. Therefore, the spark plug itself will be somewhat different for smaller engines versus larger engines.

Combustion itself is under a great deal of pressure in the gasoline engine. The spark plug accommodates the pressure forces of the combustion reaction instance by providing up to 7000 psi locking of the spark plug's fuel delivery chamber during the combustion process. However, during the other steps in the 2 or 4 cycle process the spark plug will allow the flow of fuel through the head of the plug and into the top dead center portion of the cylinder with pressures starting as low as 4 psi. A hybrid fuel system is required to deliver the hybrid fuel to head of the spark plug. The vacuum produced during the intake process of the cycle combined with pressure from the hybrid fuel line will enable a valve in the plug tail to open letting the hybrid fuel into the top dead center portion of the cylinder. The amount of pressure in the hybrid fuel rail can be varied in order to accommodate the revolutions per minute (RPM) of the piston(s) in the engines cylinder(s). Higher pressures will increase the amount of hybrid fuel injected top dead center of the cylinder and will also increase the rate of delivery to the cylinder. A venturi cooling affect on the fuel can also be observed for gaseous fuels as they flow from a high pressure fuel rail into the cylinder head of the engine. Flow of the hybrid fuel into the engine is stopped momentarily by the compression process, which closes the valve in the tail of the spark plug.

Electricity is provided to the plug in the common method. The anode of the plug itself encompasses the fuel delivery to the head of the spark plug while also providing the conductivity of the electrons in the electrical current used to generate a Tesla spark on the head of the plug. The position of the spark plug in the combustion engine is just above top dead center. Delivery of the hybrid fuel to the head of the spark plug accomplishes two important objectives relative to combustion. The first objective is to allow even fuel diffusion to the head of the cylinder near the location of ignition. The second objective is that it allows the electrical current of the spark plug to act on the hybrid fuel directly in the extended combustion chamber region of the plug head. The later is extremely important when hybrid fuels that diffuse rapidly such as hydrogen. The later also supports the simultaneous electrolysis of non combustible fuels into immediate combustible fuels. In the case of water it can be electronically converted to hydrogen and oxygen at the head of the spark plug which will behave as an electrolysis electrode that instantaneously separates water molecules into Hydrogen and Oxygen at the high voltage that the combustion engine delivers to the spark plug during each instance of combustion in the 2 or 4 stroke engine.

The same plug can also be introduced into engines that do not leverage spark plugs, such as the diesel engine. The diesel engine combusts via pre-ignition through combustion when the piston is top dead center. If the hybrid fuel used supports pre-ignition the plug itself can be used merely as a delivery mechanism by which hybrid fuel is brought to the diesel cylinder, but the electrical capacity of the spark plug is left disabled. If a hybrid fuel such as water is chosen which denigrates the capacity of the diesel engine to pre-ignite under compression, the spark plug can be used to instantaneously split the water into hydrogen and oxygen at the time the piston is at the top of the diesel cylinder in the compression stroke, because the spark plug does not have any protruding electrodes that would come in contact with the cylinder. The same extension of the cylinder size relative to combustion must be accounted for in the diesel engine as it was in the gasoline engine.

### SUMMARY OF THE INVENTION

The design outlined here enables anyone to convert their standard gasoline combustion engine into a hybrid combustion engine that can run on different types of fuels. The design of the plug simplifies the means of introducing a hybrid fuel delivery mechanism to an internal combustion engine without disturbing the initial method of combustion of the engine. Therefore, the spark plug supports the normal combustion properties of the engine when the hybrid fuel reserves are depleted or absent. In addition the plug supports both liquid and gaseous hybrid fuel delivery and is capable of delivering the hybrid fuel within a large range of pressures without the risk of back flow to the fuel rail. The device can be used with or without electricity to deliver fuel. This allows one to implement the capabilities to enhance engines that leverage combustion without spark plugs, such as diesel engines that traditionally leverage pre-ignition.

The combustion chamber extension of the plug that is implemented by introducing a cavity in the center and body of the spark plug supports high pressures required for combustion and seal the combustion chamber allowing the combustion process to occur under high pressure as designed by the manufacturer of the engine without fuel seepage that can result in uneven combustion or knocking of the piston against the cylinder during the combustion process.

The Physical Chemistry of the normal combustion process of the engine as designed by the manufacturer is maintained by allowing for stable extension of the cylinder such that compression is not lost. This is critical with respect to engine performance and the systems that monitor the engines performance. Delivery of a hybrid fuel through the spark plug easily introduces hybrid fuel for aspirated combustion engines and also bypasses the computer controls of more complex engines that leverage electronic fuel injection. The ability to use the spark plug with the electronic fuel injection system is critical because the spark plug fuel delivery does not need to be governed by the electronic fuel injection system. Instead the hybrid fuel can be delivered at a constant pressure, which simplifies the fuel delivery rail and system required. However, the hybrid fuel injection mechanism of the spark plug will allow for the introduction or merger of the fuel rate delivery mechanism of the plug to be integrated with electronic controls or even integrated with the electronic fuel injection electronics.

### BRIEF DESCRIPTION OF THE DRAWINGS

FIG. 1 is an illustration of the outer portion of the spark plug. The Plug consists of a metallic body (2) consisting of a threaded end (1) that can connect to an engine head. Traditionally the universal thread type is 14mm wide. The plug has a typical fastener grip for connecting it to compression hose/tubing (5) for fuel delivery and a grip for tightening the plug to the engine (3). A threaded female connector with ½ inch NPT threads (6) is available for fuel line interconnectivity at the tail of the spark plug. The internal body of the plug consists of a non conducting material capable of withstanding high temperatures and high pressure.

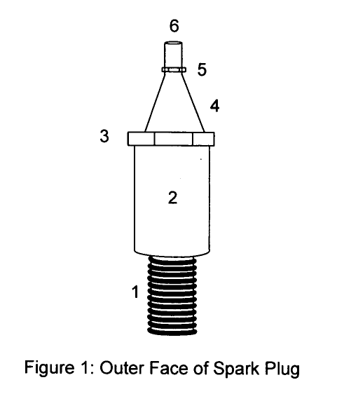

FIG. 2 is a cross sectional illustration of the center of the spark plug. There is an electrode (7) that extends from the head of the plug to the tail of the plug and is hollow in the middle, and ends in open mouth “̂” shape where each tip can conduct a spark. A fuel exit hole (9) allows a hybrid fuel to enter the electrode chamber (8). A valve composed of a spring (10) and a ball bearing (11) restricts flow into the hollow core of the spark plug. The combustion chamber extension (12) is the hollow core of the spark plug.

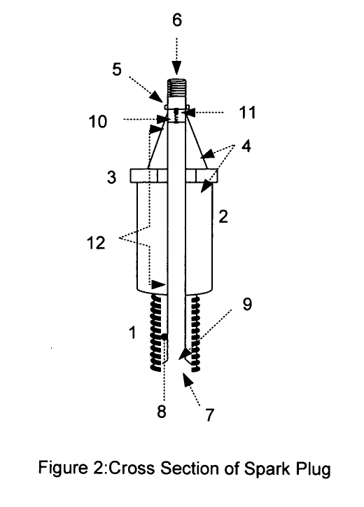

FIG. 3 illustrates how the materials use for the electrode tip can be adjusted in shape to end in a rounded head (7b) with fuel exit portal (9b) adjacent to the normal ground overhang (1b) protruding from the end of the threads on the head of the plug.

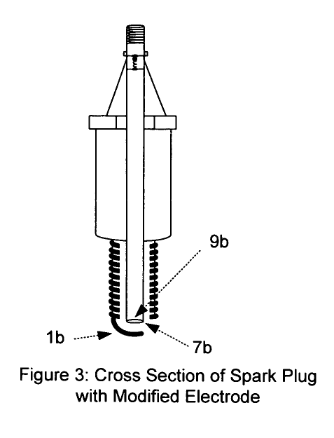

FIG. 4 shows how the size of the plug can be reduced in order to reduce the spark plugs extension of the combustion chamber (12b). It also indicates that the area within the threads (1) adjacent to the electrode (7) can be adjusted with filler (12c) to adjust the thermal properties of the plug.

FIG. 5 illustrates how the design of the spark plug allows it to be implemented into the head of a conventional engine.

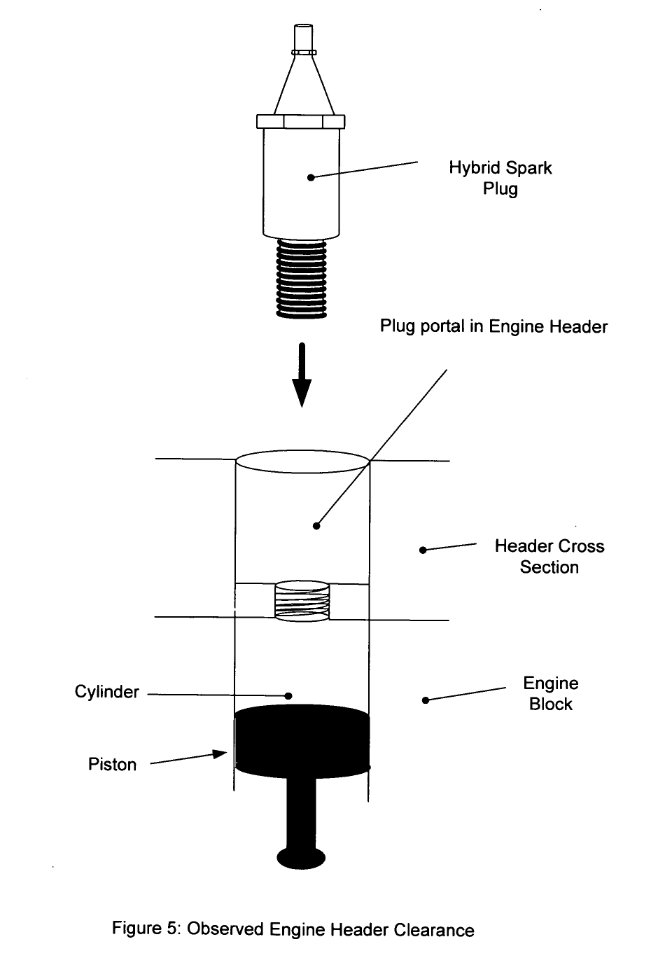

FIG. 6 shows the difference between the said invention and previous designs of spark plugs similar to the said invention. The demonstrated clearance in the said invention is illustrated by the lack of side arm fittings.

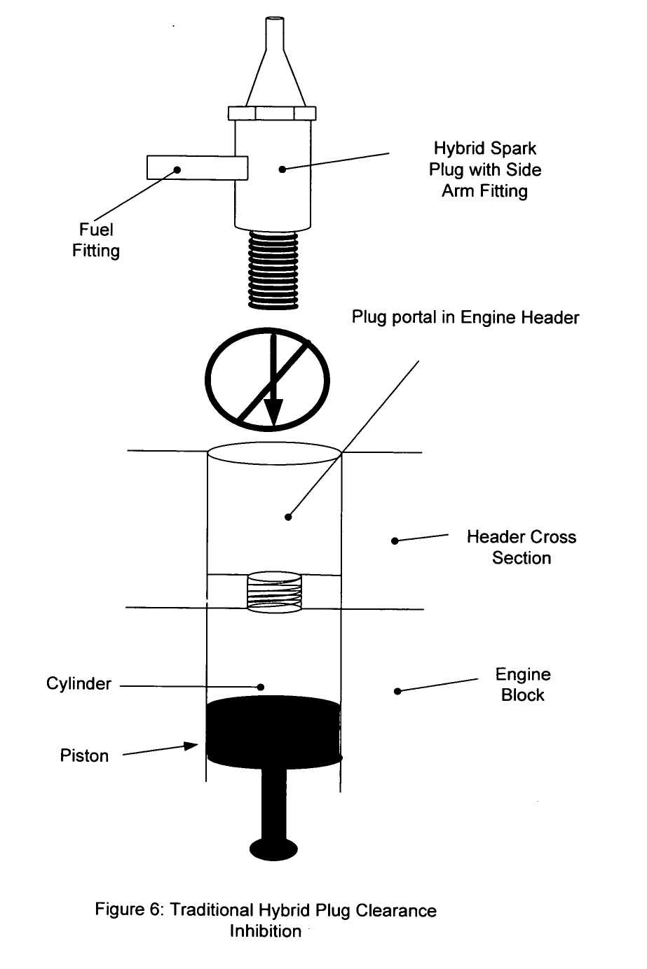

FIG. 7 displays how a typical wire (13) can be easily connected to the tail of the plug where the compression fitting (14) for the fuel line (15) is attached.

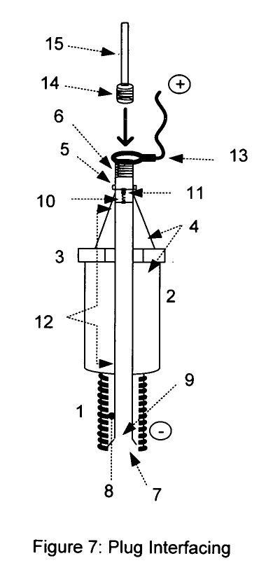

### DESCRIPTION OF THE PREFERRED EMBODIMENT

The design of the hybrid spark plug is very similar to the design of a conventional spark plug in that is has no side arm fittings and can therefore be used in the same contexts as a conventional spark plug relative to and internal combustion engine. The plug has the traditional universal spark plug threads (1) which allow the plug to be fastened to the head of the engine. Typically these are 14 mm, but any size thread can be implemented. The body of the plug consists of stainless steel on the outer shell (2), which provides the spark plug with the negative cathode connection. A grip for fastening (3). The inner guts of the plug consist of a non-conducting filler (4) which can be composed of either a non-conducting polymer or a non-conducting ceramic material. The material of choice must have the capacity to bond tightly to the electrode (7) for the purpose of anchoring the electrode and sealing the body of the hybrid spark plug to keep it from leaking gases during the combustion process. In addition the non conducting material (4) will shield the positive connection of the plug to keep it from forming external Tesla sparks outside the cylinder at the tail of the plug.

The tail of the plug consists of a fastener grip (5) and a female threaded ½ inch NPT thread fitting (6) that allows for the interfacing of the sparkplug to conventional compression fitting and hoses that can be attached in a number of conventional ways to the tail of the plug and to a hybrid fuel rail. The material chosen for the connection will be relevant to the hybrid fuel chosen and the pressures and temperatures that the internal combustion engine will run at.

The material used for the positive anode (7), which encompasses the anodic portion of the electrode (8) can be composed of different materials depending on the internal combustion engines requirement. Copper, Iron, and stainless steel are recommended, but platinum is not. Platinum can perform an electronic formation of water from hydrogen and oxygen when they are in gaseous forms, which can slow the rate of hydrogen and oxygen formation from water during the combustion process. When water is used as a hybrid fuel it is important to recognize that the design of the plug must support instantaneous splitting of water into hydrogen and oxygen electronically in order to instantaneously support the thermodynamic combustion of hydrogen and water. Traditionally copper is used in small 2 cycle and 4 cycle engines because the anode of the plug runs hotter and supports more complete combustion at lower voltages than larger engines. Marine applications include the use of stainless steel for the anode (7) and may have a rounded head (7b). The material and design of the head of the plug impacts the potentials that are possible to induce Tesla sparks and the thermal conductivity of the material impact the joule transfer of heat across the plug.

The hybrid fuel is introduced through a portal (9) at the tip of the spark plug head. The diameter of the electrode's hollow center can be increased (9b) to allow greater hybrid fuel flow if required. The hybrid fuel is allowed to flow into the body and ultimately the head of the spark plug via a valve at the tail of the spark plug. This valve is composed of a spring (10) that holds a metal ball bearing (11) against an orifice in the anode. The spring (10) has a spring constant that is strong enough to keep the ball bearing (11) against the orifice in order to allow sealed compression at pressures up to 7000 psi. This means that the plug can operate on standard fuel alone when the hybrid fuel is depleted. However the spring constant also allows the ball to be pushed forward from the inlet (6) at low pressure ˜4 psi in order to introduce the hybrid fuel into the body and head of the spark plug. In addition the ball bearing used for hydrogen hybrid fuel introduction should be composed of palladium & silver (12%) alloy, which enhances the valve inlet capacity to higher flow rates than steel by allowing the hydrogen to penetrate the valve bearing like a membrane and to arrest backfire. The valve (10,11) itself arrests hybrid fuel backfire just as the mechanical valves of the engine keep the cylinder contained during combustion.

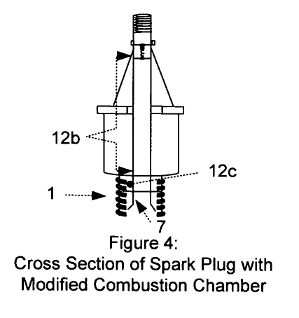

When designing the plug for an engine, the extension of the cylinders combustion space must be taken into consideration. The combustion chamber of an internal combustion chamber has an absolute error affiliates with the physics of combustion that will support the extension of the combustion chamber to a limit. Once the limit is exceeded the materials of the combustion chamber can be subject to affects that denigrate the capacity of the combustion reaction. Therefore smaller spark plugs with smaller combustion chamber extensions (12b, 12c, FIG. 4) are used for smaller engines that typically do not have battery driven ignition coils and contain small cylinder volumes.

The spark plug can be interfaced to a battery by attaching an electrical connector (13) with a wire that is sent to the distributor of positive current for the engine. A traditional fitting with a male V₂ inch NPT thread for compression (14) can be attached to the tail of the plug (6). The choice of compression fitting and hose/tubing used is relevant to the hybrid fuel used. The hose/tube (15) is then connected to the fuel rail. When a metal tube is used it makes sense to use shielding on the tubing to avoid electric shock.

The pressure of the fuel line and rail used to deliver the hybrid fuel to the hybrid spark plug is dependant on the physical properties of the hybrid fuel itself. One needs to take into consideration the flow rate and the impact to the air to fuel ratio of the engine as it operates with either carbureted or electronic fuel injection. The valve mechanism (10,11) at the tail of the plug serves a very important role. The valve allows for the creation of a sealed combustion chamber, but also allows for fuel intake. It is possible to interface the system that pressurizes the fuel rail to a computer that monitors the RPM of the engine for the purpose of increasing hybrid fuel delivery at higher RPMs.

1) Dependent claim 1 references Independent claim 1. Universal spark plug fitting compatibility with modern and legacy 2&4 stroke combustion engines is supported by the valve spark plug design so that it can be implemented on any engine using conventional spark plugs.

2) Dependent claim 2 references Independent claim 1. The anode of the valve spark plug also serves as the liquid and/or gaseous hybrid fuel line that can be attached to a secondary fuel rail.

3) Dependent claim 3 references Independent claim 1. The ability to change the type of secondary hybrid fuel without changing the valving delivery mechanism that brings the fuel to the top dead center location of the combustion chamber.

4) Dependent claim 4 references Independent claim 1. The capacity to deliver a non-combustible fuel and create a combustible fuel by way of electrolysis of the non-combustible fuel via the anode just prior to the combustion reaction in the combustion chamber.

5) Dependent claim 5 references Independent claim 1. The capacity to deliver a non-combustible fuel to the top dead center of the combustion chamber of a combustion engine that will undergo thermal expansion via a phase change to a gas from a liquid when energy is introduced to the non-combustible fuel during the combustion process.

6) Dependent claim 6 references Independent claim 1. The combustion chamber of the engine is increased in volume by the spark plug valve chamber but supports normal closed combustion by a primary fuel even when no hybrid fuel is introduced through the valve.

7) Dependent claim 7 references Independent claim 2. The palladium & silver alloy used will support the diffusion of Hydrogen across the valve head when closed while simultaneously supporting back flow inhibition of the combustion process to the fuel rail.

8) Dependent claim 8 references Independent claim 2. The capacity to introduce Hydrogen at flow rates higher than a traditional valve by implementing a Hydrogen permeable valve head into the valve spark plug.

9) Dependent claim 9 references Independent claim 1. The capacity to run the valve spark plug on any conventional combustion engine on the primary petroleum based fuel reserves after the hybrid fuel has been depleted from the hybrid fuel reserves.

10) Dependent claim 10 references Independent claim 1. The valve inhibits backflow combustion spill over into the hybrid secondary fuel line by leveraging a closing mechanism that keeps combustion contained in the top dead cylinder region at pressures that are 4000+PSI.

11) Dependent claim 11 references Independent claim 3. The valve spark plug allows introduction of liquid & gaseous hybrid fuels to the engine without passing traditional sensors used to manage air/fuel ratios.
